(19) United States
(12) Patent Application Publication
(10) Pub. No.: US 2020/0055416 A1
(43) Pub. Date: Feb. 20, 2020

(54) ELECTRIC VEHICLE CHARGING SYSTEM FOR EXISTING INFRASTRUCTURE

(71) Applicant: Zaptec IP AS, STAVANGER (NO)

(72) Inventors: Brage W. Johansen, Royneberg (NO); Kjetil Naesje, SANDNES (NO)

(21) Appl. No.: 16/344,804

(22) PCT Filed: Oct. 28, 2016
(86) PCT No.: PCT/EP2016/076116

§ 371 Date: Apr. 25, 2019

(51) Int. Cl. B60L 53/31; B60L 53/16; B60L 53/30; B60L 53/63

(52) U.S. Cl. CPC B60L 53/31; B60L 53/63; B60L 53/305; B60L 53/16

(57) ABSTRACT

The invention concerns a multipurpose charging system suitable for supplying charging power to an electricity-powered vehicle. The charging system comprises a plurality of spaced apart fixtures, where each fixture comprises a power inlet for receiving electrical energy. At least one of the fixtures is an EVSE fixture comprising a control device system comprising an EVSE control device and an EV plug, where the EVSE control device is configured to charge, via the EV plug, a rechargeable battery powering the electricity-powered vehicle. The energy transfer from the EV plug to the battery may take place via a charging cable. The charging system further comprises a primary power source arranged outside the fixtures for supplying electric energy (PS) to the power inlet of each of the fixtures, one or more second electric loads arranged at least partly within at least one of the fixtures and a solid state transformer system arranged within the at least one EVSE fixture. The solid state transformer system comprises at least an EVSE solid state transformer having a primary side being electrically connectable to the primary power source for receiving electric energy at a voltage level V_{PS} and a secondary side providing electric energy at a voltage level V_{EVSE}, the secondary side being electrically connectable to the EVSE control device, either directly or indirectly.

### TECHNICAL FIELD

The present invention relates to a charging system for providing electricity to electricity-powered vehicles and a method for installing such a system. The charging system is particularly adapted for constituting part of a multi-functional charging system for integration into an existing urban infrastructure.

### BACKGROUND AND PRIOR ART

In recent years there has been a drive towards cleaner vehicles; in particular governments have encouraged the use of electric cars. This is increasingly being achieved through legislations. The tendency is to penalise owners and drivers of larger petrol and diesel vehicles and encourage the use of clean vehicles—such as electric or hybrid vehicles.

The rapid increase in electricity-powered vehicles create however challenges, especially in urban locations such as inner cities. For examples, setting up new charging stations is an expensive exercise, requiring earthwork for cabling and purchase of extensive new infrastructure. The need of blocking at least parts of the locations traffic network may be very disruptive to city traffic, thereby triggering further costs.

Systems and methods that may deliver electricity to charge batteries of electricity-powered vehicles which includes a large number of charging stations making use of already existing municipal facilities such as street lights and parking meters have therefore acquired a high degree of attention in the last years, in particular from governmental authorities.

Configurations, maintenance, and operation on charging stations must be performed with a minimum amount of manual configuration work in order for non-expert service technicians to carry out the work. The charging stations are preferably equipped with plug system, thereby avoiding the need for authorized electricians.

Installing charging stations in existing municipal facilities are known. As a typical example, FIG. 1 shows a prior art charging system where a municipal power grid 80 delivers energy to a nearby charging station 1a arranged within a fixture.

Electricity powered vehicles may thus charge their batteries by electrically connecting the charging cable to power outlets 21 which again is electrically connected to a control system 20. The charging station 1a may route the available power to the control system or to other charging stations 1a by us of dedicated connection box 50.

Examples of such prior art systems may be found in patent publications WO 2012/122072 A2 and WO 2013/034872 A2.

However, such prior art solutions necessitate arrangements of the charging systems outside the existing municipal facility, making these solutions less compact. In addition, the charging stations must accept incoming power levels equal to the power levels available in existing municipal power grids. Alternatively, the power level or the power grid must be at acceptable charging powers for electricity-powered vehicles, normally 230 V or 110 V.

### OBJECTS OF THE INVENTION

An object of the invention to provide scalable, compact and highly secure charging system for electricity-powered vehicles (EV) which may be easily integrated into a fixture of an existing or new urban infrastructure such as lamp posts, parking meters and the like.

Another object of the invention is to provide the above charging system that allows use of existing or new urban infrastructures having limited internal space for installation of new electrical components.

Another object of the invention is to provide the above charging system that allows lower power losses compared to traditional charging systems.

Another object of the invention is to provide the above charging system that allows less dependency on available power grids' electrical characteristics.

Another object of the invention is to provide the above charging system that allows safe charging of EVs from unearthed electrical networks such as the IT system.

Another object of the invention is to provide the above charging system that allows distribution of available power from the power grid in the most efficient way.

Various other objects and advantages of the invention will become apparent to those skilled in the art by perusing the accompanying specification, drawings and claims.

### SUMMARY OF THE INVENTION

The present invention is set forth and characterized in the main claims, while the dependent claims describe other characteristics of the invention.

In particular, the invention concerns a charging system suitable for supplying charging power to an electricity-powered vehicle. The charging system comprises at least one fixture of type EVSE fixture, wherein each EVSE fixture comprises at least one power inlet for receiving electrical energy, an EVSE control device and an EV plug. The EVSE control device is configured to charge, via the EV plug, a rechargeable battery powering the electricity-powered vehicle. The energy transfer from the EV plug to the battery may take place via a charging cable. The charging system further comprises a primary power source arranged outside the at least one EVSE fixture for supplying electric energy (PS) to the at least one power inlet of the at least one EVSE fixture. The charging system is characterized in that the at least one EVSE fixture further comprises at least an EVSE solid state transformer having a primary side being electrically connectable to the primary power source for receiving electric energy at a voltage level V_{PS} and a secondary side providing electric energy at a voltage level V_{EVSE}, the secondary side being electrically connectable to the EVSE control device, either directly or indirectly. For example, the secondary side may be permanently connected to the EVSE control device or connected manually or remotely by a connection box containing one or more relays.

The above mentioned primary power source may be a power grid delivered by local or national authorities and may be configured to deliver power to the power inlet either directly by arranging dedicated cables to each fixture, or indirectly via another fixture. The latter may be accomplished by use of connection boxes with suitable relays.

In an advantageous embodiment both the EVSE control device and the EVSE solid state transformer system are arranged fully within the at least one fixture.

In another advantageous embodiment the charging system includes a plurality of spaced apart fixtures, each having at least one power inlet for receiving electrical energy. At least one of the plurality of fixtures is in this particular embodiment of type EVSE fixture.

In yet another advantageous embodiment the charging system is a multipurpose charging system further comprising a second electric load arranged at least partly within the at least one fixture. This second electric load may be electrically connectable to the EVSE control device system.

In yet another advantageous embodiment each of the at least one fixture contains a solid state transformer system comprising the EVSE solid state transformer and a second solid state transformer arranged within at least one of the at least one fixture. The second solid state transformer comprises a primary side being electrically connectable to the primary power source for receiving electric energy at the voltage level V_{PS} and a secondary side providing electric energy at a voltage level V_{EL}. The secondary side is in this embodiment electrically connectable, directly or indirectly, to the second electric load. The second solid state transformer may be arranged in parallel to the EVSE solid state transformer within the solid state transformer system.

In yet another advantageous embodiment the primary side of the EVSE solid state transformer, or both the EVSE solid state transformer(s) and the second solid state transformer(s), is/are electrically isolated from the secondary side of its/their respective solid state transformer(s).

In yet another advantageous embodiment the voltage level V_{PS} is higher than the voltage level V_{EVSE}.

In yet another advantageous embodiment the voltage level V_{PS} is equal to, or approximately equal to, the voltage level V_{EVSE}.

In yet another advantageous embodiment each EVSE fixture of the at least one fixture comprises monitoring means configured to monitor physical parameters descriptive of the performance of the EVSE solid state transformer and transmission means configured to allow access and transmission of the physical parameters to computer networks, for example via cloud based storage systems. The primary side of the EVSE solid state transformer may in this embodiment be electrically isolated from the secondary side of the EVSE solid state transformer, and the monitoring means and the transmission means may be configured to detect and to transmit, respectively, any insulation fault occurring within the EVSE solid state transformer. The transmissions may be to power grids and/or any consumers of electric energy.

In yet another advantageous embodiment the EVSE solid state transformer comprises a protection device enabling measurement and/or detection of any anomalous electrical behaviour such as transient overvoltage, undervoltage, power consumption, earth fault, excess temperature, electric noise, or a combination thereof. The measurement/detection is followed by transmission of the parameter(s) to a computer network, for example a cloud based data storage. A detection of an earth fault may be obtained by use of one or more earth fault protection relays.

In yet another advantageous embodiment the charging system further comprises a communication module configured to receive and transmit data from/to the fixtures and/or a computer network, for example via a cloud service. The communication module may further be configured to receive and transmit data from/to the primary power source.

In yet another advantageous embodiment each EVSE fixture comprises an EVSE data communication device enabling reception and transmission of data between the EVSE control device and the EVSE solid state transformer.

In yet another advantageous embodiment the EV plug comprises an EV power outlet and an EV communication module, wherein the EV communication module is configured to transmit data to a computer network, for example to/via a cloud service.

In yet another advantageous embodiment the charging system includes a plurality of spaced apart fixtures including at least one being of type EVSE fixture and that each fixture have at least one power inlet for receiving electrical energy. Furthermore, each fixture comprises in this embodiment a connection box comprising a plurality of relays.

The connection box is configured to electrically connect and/or disconnect the at least one power inlet with the EVSE solid state transformer and electrically connect and/or disconnect the at least one power inlet with the at least one power inlet of another of the fixture within the charging system.

In yet another advantageous embodiment each EVSE fixture comprises a plurality of EVSE plugs configured to connect and disconnect at least the EVSE control device and the EVSE solid state transformer to/from the respective EVSE fixtures. The EVSE plugs comprises a control system plug electrically connected to the EVSE control device and a power inlet plug electrically connected to the primary side of the EVSE solid state transformer.

All the above mentioned data communication may be obtained by use of standards such as PLC, Ethernet, RS-485, CAN-bus or any other hardwire system and/or WIFI, BLE, LoRa, GPRS, 3G, 4G, 5G or any other wireless system.

The invention also concerns a method using an existing, hollow fixture connected to a primary power source via at least one power inlet in order to provide charge for a rechargeable battery powering an electricity-powered vehicle, wherein the fixture comprises an electrical load. The method comprises the steps of
making at least one opening into the inner volume of the hollow fixture, for example by cutting or opening up existing lid(s),
cutting or removing at least one wire electrically connecting the power inlet to the electrical load,
installing an upper and a lower adaptation plug in electrical connection with the electrical load and the power inlet, respectively, and
installing the above described charging system by electrically connecting the control system plug to the upper adaptation plug and electrically connection the power inlet plug to the lower adaptation plug.

In an advantageous method the EVSE plugs further comprises an intermediate EV plug, and the method further comprises the step of installing the EV plug into one of the at least one opening and electrically connecting the intermediate EV plug into a corresponding inner plug of the EV plug.

The one or more fixtures of the charging system may constitute part of an urban infrastructure, i.e. structures, systems, and facilities serving the economy of a business, industry, country, city, town, or area, including the services and facilities necessary for its economy to function. For example, the fixtures may be part of a road network system, i.e. arranged in, or adjacent to, a road, where at least one of the second electric loads comprises a light source for providing street light to roads and/or parking lots.

In the following description, numerous specific details are introduced to provide a thorough understanding of embodiments of the claimed charging system and its method. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

### BRIEF DESCRIPTION OF THE DRAWINGS

FIG. 1 is a schematic drawing of a prior art multi-station charging system adapted for integration into an urban infrastructure,

FIG. 2 is a schematic drawing of a charging system in according with the invention comprising a fixture one or more solid state transformers allowing step down of incoming power grid voltage,

FIG. 3 is a schematic drawing of a multipurpose charging system adapted for integration into an urban infrastructure in accordance with a first embodiment of the invention, the charging system comprising a plurality of fixtures/charging stations, where each fixture includes one or more solid state transformers allowing step down of incoming power grid voltage,

FIG. 4 is a schematic drawing of a multipurpose charging system of FIG. 3, allowing internal and external data communication via cloud services,

FIG. 5 is a schematic drawing showing routing of power and data information within a multipurpose charging system of FIGS. 3-4 as well as exemplary power levels,

FIG. 6 is a schematic drawing showing possible internal electric components in a multipurpose charging system of FIGS. 3-5,

FIG. 7 is a schematic drawing of a multipurpose charging system of FIG. 3, allowing step up of a power grid voltage prior to entry into the plurality of fixtures by use of an external transformer,

FIG. 8 is a schematic drawing of a multipurpose charging system of FIG. 7 in which some fixtures of the multipurpose charging system act as multifunctional fixtures, one fixture act as an EV charging station and one fixture act as a light pole,

FIG. 9 is a schematic drawing of a multipurpose charging system adapted for an urban infrastructure in accordance with a second embodiment of the invention, the multipurpose charging system comprising a plurality of fixtures, where each fixture includes a solid state transformer allowing galvanic isolation between the EVSE of the respective multipurpose charging station and a connected power grid,

FIG. 10 is a schematic drawing of a multifunctional fixture comprising a lamp post and a retrofitted EV charging station with an integrated SST system and a control device system in accordance with the invention and

FIGS. 11(a) and (b) show schematics of a 3-phase charging assembly in accordance with the invention, where FIG. 11(a) shows several EVSE fixtures (Z) connected along a single distributing cable sharing a common 32 A fuse, the latter being connected to a main fuse of a 3-phase network grid, and FIG. 11(b) shows groups of up to 15 EVSE fixtures (Z) connected to each of a plurality of distributing cables sharing common 32 A fuses, and where the plurality of common 32 A fuses are connected in a parallel manner to a main fuse of the 3-phase network grid.

### DETAILED DESCRIPTION OF THE INVENTION

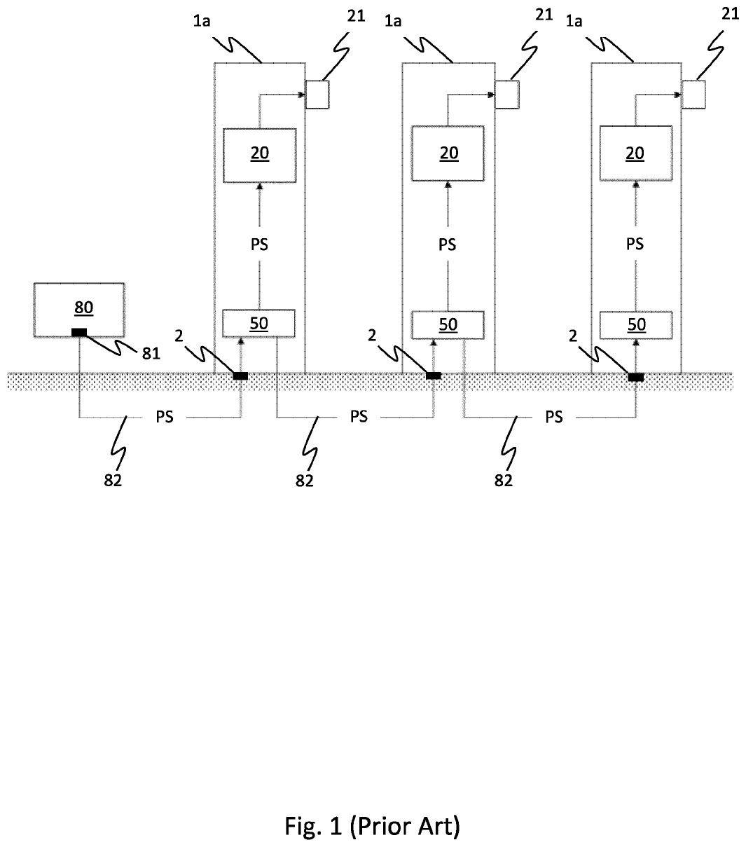

As described above FIG. 1 shows an example of a typical prior art charging system including several charging fixtures 1a.

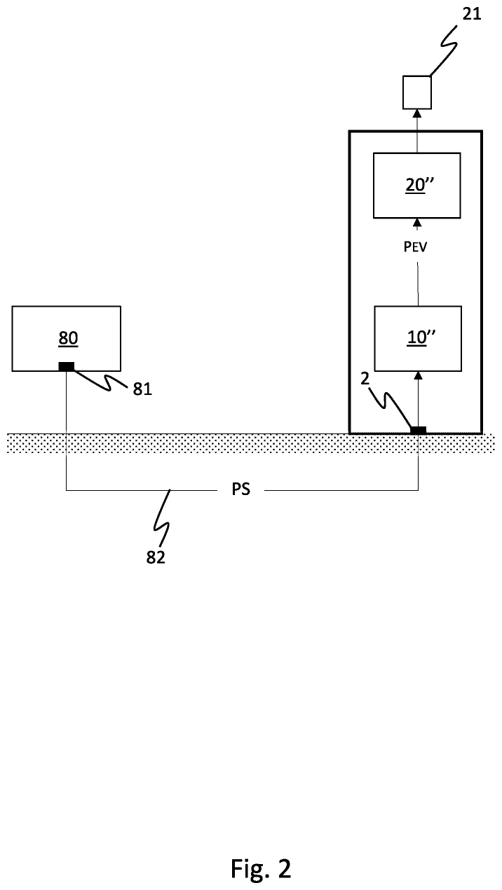

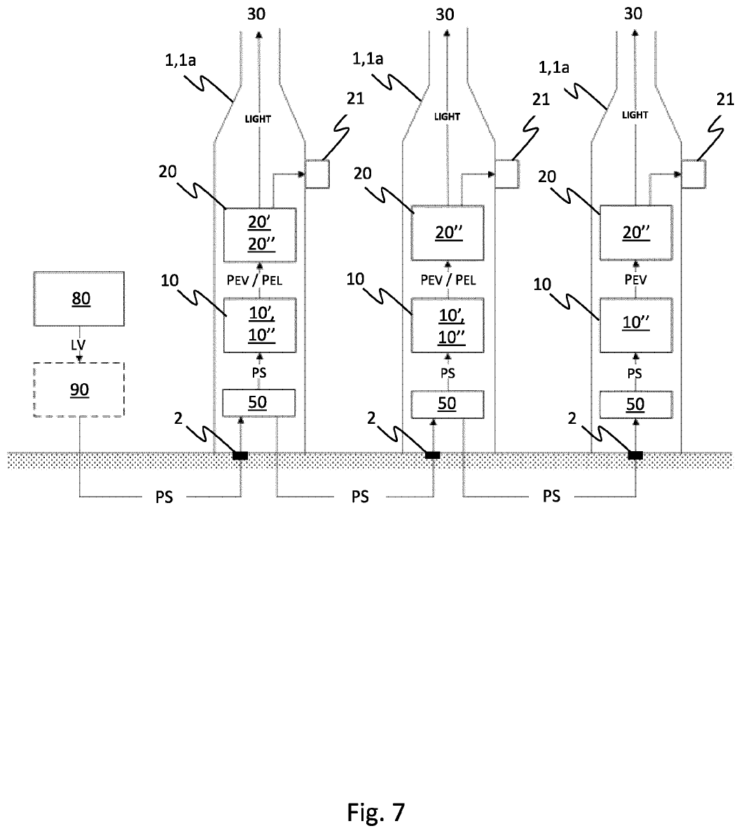

FIG. 2 shows an embodiment of a charging system in accordance with the invention, comprising one EVSE fixture only. Electric power at voltage level PS is supplied from an external power grid 80, via one or more power inlets 2 of the EVSE fixture, to a fully fixture integrated EVSE (electric vehicle supply equipment) SST (solid state transformer) 10″. The EVSE SST 10″ convert the voltage level from PS at its primary side to a voltage level P_{EV} at its secondary side adapted for charging of batteries in electricity powered vehicles. The converted power is then made available at one or more EV outlets 21 via a dedicated EVSE control device 20″. The latter may perform any modulation, re-routing, switching, etc. considered appropriate/necessary. In addition to the integrated EVSE SST 10″, an external transformer (not shown) may convert the power from the power grid 80 down/up to the desired voltage level PS. See also FIG. 7. This external transformer may advantageously be an SST, or a transformer assembly including one ore more SSTs.

A SST is herein defined as an electric energy converting device that operates at much higher frequencies (several kHz) than conventional transformers (50/60 Hz). The SST must be equipped with at least one high-frequency transformer combined with at least one electronically controlled switch (transistor or similar). The SST will also need a control system to control the switching sequence and frequency.

The very same control system may also be used to monitor voltages, currents and internal temperatures for self-protection and reporting purposes.

An example of a solid state transformer may be found disclosed in the publication 978-1-4244-2893-9/09 2009 IEEE p. 3039-3044, which is hereby incorporated as reference. In this connection particular reference is made to FIG. 1 in the publication and its related text. Such a solid state transformer has the potential of providing more space and/or save costs. Furthermore, it may facilitate more control of available data.

In addition to the criteria given by the above definition, most SSTs should preferably contain one or more of
Converter topology type DC/DC, AC/DC, DC/AC, ACf1/ACf1 or ACf1/ACf2
Power Electronics Interface (power connectors)
Communication and Control Link (networking and control signal connectors)
Insulation means
Cooling means
Mechanical encapsulation

SSTs are described in literature under a large variety of names. The following names give a non-exhaustive list of transformers that all fall under the above definition of SST:
Electronic Transformer (McMurray)
Intelligent Universal Transformer—IUT (EPRI)
Power Electronics Transformer—PET (ABB)
Energy Control Center—ECC (Borojevic)
Energy Router—ER (Wang)

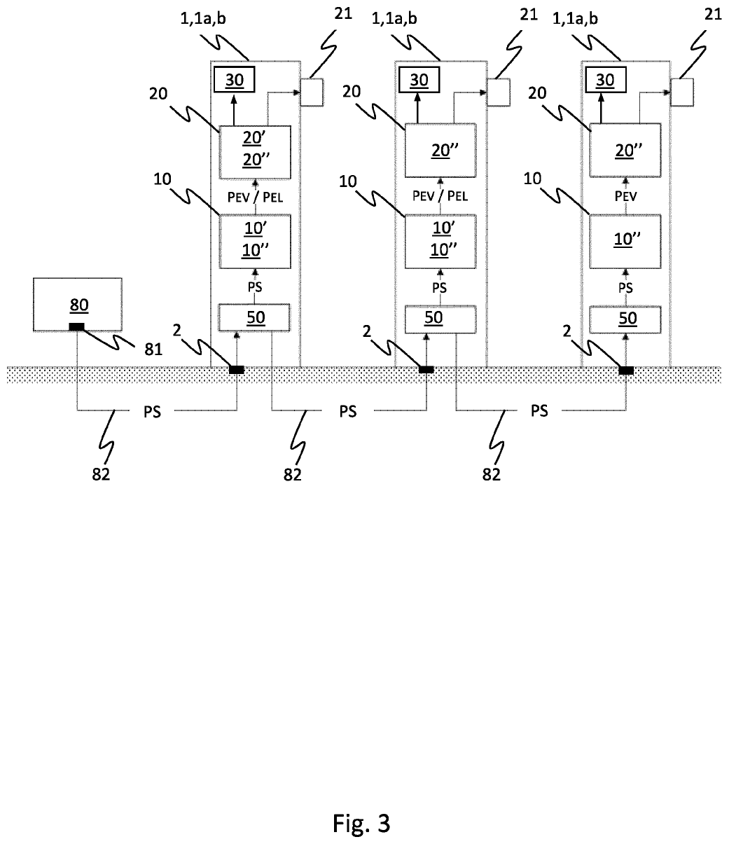

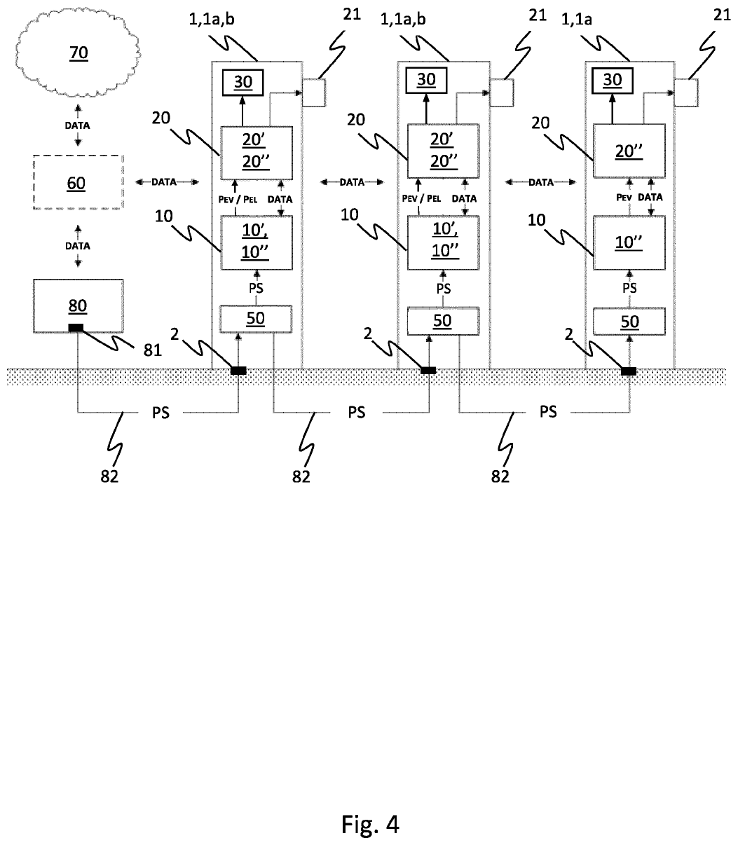

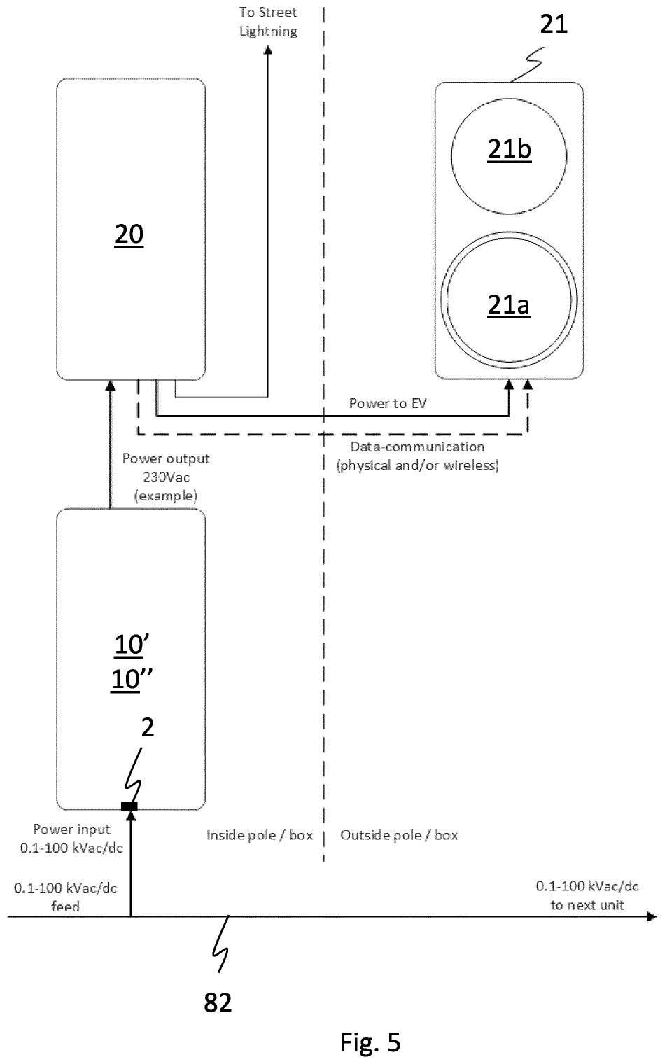

FIGS. 3 and 4 show embodiments of a multifunctional charging system in accordance with the invention comprising three power grid 80 connected fixtures 1a with EV outlets 21 acting as charging stations for electricity powered vehicles (EVs). The power inlet 2 of the leftmost fixture 1a, i.e. located closest to the power grid 80, is connected directly to the power outlet 81 of the power grid 80 through one or more suitable power lines 82, for example power lines using power line communication (PLC). The power from the power grid 80 is further routed to a solid state transformer (SST) system 10 by use of a connection box 50 arranged within the fixture 1a. The SST system 10 comprises two different SSTs 10′,10″, where one SST, hereinafter referred to as an EVSE SST 10″, is configured to convert the voltage power level of the power grid 80, hereinafter referred to as PS, to a voltage power level suitable for charging commercially available EVs, hereinafter referred to as P_{EV}. Examples of typical P_{EV}s are 230 V and/or 110 V (1-phase AC) or 400 V (3-phase AC). Another SST, hereinafter referred to as EL SST 10′, is configured to convert PS to the power level suitable for an electric load 30 integrated into the same fixture 1a, hereinafter called P_{EL}. Such electric load may be a lamp post (see FIG. 5), a parking meter, a vending machine, or any other electric loads that forms part of an urban infrastructure.

After having been converted PS to the desired power level(s) by the SSTs 10′,10″ a control device system 20 further routes, and possible modulates, the power prior to be sent to the electric load(s) 30 and/or the EV outlets 21. The control device system 20 may comprise two different control devices 20′,20″ for handling converted power from the SSTs 10′,10″. The control device(s) 20′,20″ may comprise relays, frequency converters, AC/DC converters, or any other components enabling routing and/or modulation of voltage power and data communication signals.

As better illustrated in FIG. 4, each control device system 20 may further include components allowing data communication with other components within the same fixture 1a, as well as data communication with other fixtures 1a and/or other external devices such as cloud based services 70, mobile phones, computers, etc. FIG. 4 shows an example where data is transmitted from the fixtures 1a to cloud services 70 and/or power grids 80 via one or more communication modules 60. The data communication may be achieved by any hardwire based data communication standards such as PLC (Power Line Communication), Ethernet, RS-485, CAN-bus. Alternatively, or in addition, the data communication may be based on wireless connection by use of for example WIFI, BLE (Bluetooth low energy), Long Range Radio (LoRa®) technology, GPRS (General Packet Radio Service), 3G, 4G, 5G.

In the embodiments shown in FIGS. 3 and 4 the remaining fixtures 1a (the middle and rightmost fixture 1a) are electrically connected to the leftmost fixture 1a by connection boxes 50 and power lines 82. In an alternative embodiment a plurality of power lines 82 may be connected from the power grid 80 directly to the power inlet 2 of each of the fixtures 1a. In another alternative embodiment, some of the fixtures 1a receive power from the power grid 80 via another fixture 1a and the remaining fixture(s) 1a receive(s) power directly from the power grid 80.

Data communication may also take place, hardwired and/or wireless, between the SST system 10 and the control device system 20. Further, transmitters/receivers may be arranged within the SST system 10 in addition to, or in instead of, within the control device system 20. And as illustrated in FIG. 5, transmitters/receivers may also, or alternatively, be arranged within or to the EV plug 21. The latter EV plug configuration is shown in FIG. 5 where the EV plug 21 includes an EV power outlet 21a and an EV communication module 21b. In this embodiment the SST system 10 within each or some fixtures 1a is fed with a power grid voltage PS in the range 0.1-100 kV (ac or dc) from the power grid 80 via a power line 82 and the respective power inlets 2. One or more of the SSTs 10″ convert the PS to a voltage EV suitable for both EV charging and street lightning, for example 230 V (ac or dc).

The voltage is routed and optionally modulated by the control device system 20 for further supply to the electric lamp and the EV power outlet 21. If the supply is performed via PLCs or other data communication means, any information concerning the performance of the control system 20 and/or the SST system 10 may be communicated as well to the EV communication module 21b. The stipled vertical line in FIG. 5 shows the boundary between the inside and the outside of the fixture 1a. An AC/DC converter may be installed within the SST system 10 and/or the control device system 20 if needed.

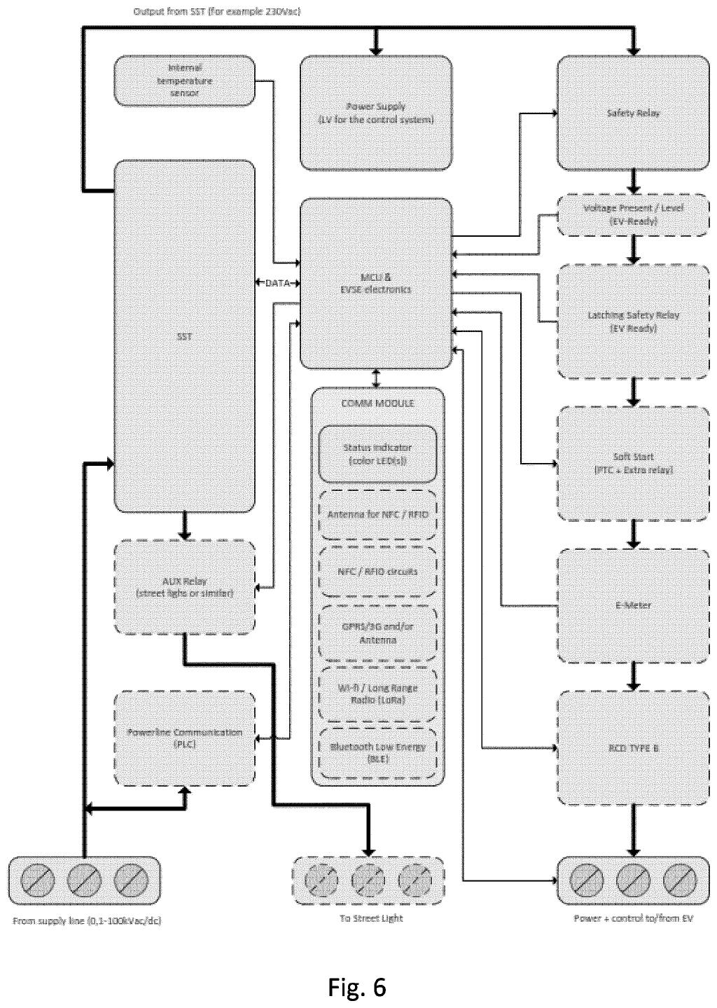

Further details of the electrical installations within an EVSE fixture 1a are shown in FIG. 6. The components indicated with a stipled line frames represent optional component in a preferred embodiment, i.e.
electric load to provide street light,
powerline communication (PLC),
AUX Relay (for street lights etc),
a communication module including
   Antenna for Near Field Communication (NFC)/Radio-frequency identification (RFID),
   NFC/RFID circuits,
   GPRS/3G and/or Antenna,
   WiFi/Long Range Radio (LoRa®),
   Bluetooth Low Energy (BLE)
Sensor for detecting presence of voltage/level (EV-Ready),
Latching Saftey Relay (EV Ready)
Soft Start (PTC+Extra relay),
E-Meter,
RCD Type B.

Note however that components considered necessary for implementation of the invention are defined in the main claims.

FIG. 7 shows an embodiment of the invention where the electric load 30 within each fixture 1a acts as a lamp post. The leftmost fixture 1a comprises a SST system 10 with both an EVSE SST 10″ and an EL SST 10′ and a control device system 20 with both an EVSE control device 20″ and an EL control device 20′. The middle fixture 1a comprises a SST system 10 with both an EVSE SST 10″ and an EL SST 10′ and a control device system 20 with only an EVSE control device 20″. The rightmost fixture 1a comprises a SST system 10 with only an EVSE SST 10″ and a control device system 20 with only an EVSE control device 20″. All fixtures 1a provide suitable powers for both an EV when plugged to the EV outlet 21 and the lamp post 30. FIG. 6 also indicates a possible up transformation from voltage power level LV from the power grid 80 to a voltage power level PS to the fixtures 1a by use of a dedicated transformer 90.

FIG. 7 shows an embodiment of the invention similar to the embodiment shown in FIG. 6. However, among the illustrated four fixtures 1,1a,1b, the second leftmost fixture 1a is configured to only offer charging facilities for EVs, i.e. a EV charging station, while the second rightmost fixture 1b is configured to only provide power to the electric load, here exemplified by a lamp post. The leftmost and rightmost fixture 1a provide power to both electric loads 30 and EVs as described above. As for the embodiment in FIG. 6, FIG. 7 also illustrates an optional up transformation by use of a separate transformer 90 from a power LV from the power grid 80 to a power PS to the various fixtures 1,1a,1b.

The transformation of a high voltage power PS supplied by a power grid 80 down to a lower voltage power P_{EV}/P_{EL} suitable for charging the EV and/or any other electric loads 30 connected within the same fixture 1a has the advantage of lowering the energy loss within the charging system. The reason for this can be summarized as follows: Any power grid 80 may deliver a maximum power PSₘₐₓ. Further, power lost in the wires can be calculated as Pₗₒₛₛ=R_{wires}*I²_{grid}, with R_{wires} being the resistance of the wires and I_{grid} being the current passing through them. Power at the load, P_{load}, is calculated as P_{load}=V_{grid}*I_{grid}, where V_{grid} is the voltage provided by the power grid. If the supplied voltage from the power grid, V_{grid}, is doubled (V′_{grid}=2*V_{grid}), the same power at the load P_{load} is obtained by use of half of the original current ½*I_{grid}, hence inducing power loss Pₗₒₛₛ of only a quarter of the power (P′ₗₒₛₛ=¼*Pₗₒₛₛ).

Another important advantage of allowing higher voltage power into each fixture is the availability. A user or operator of the charging system may choose to upgrade or downgrade the available voltage power within one, some or all of the fixtures 1a at any time of the day.

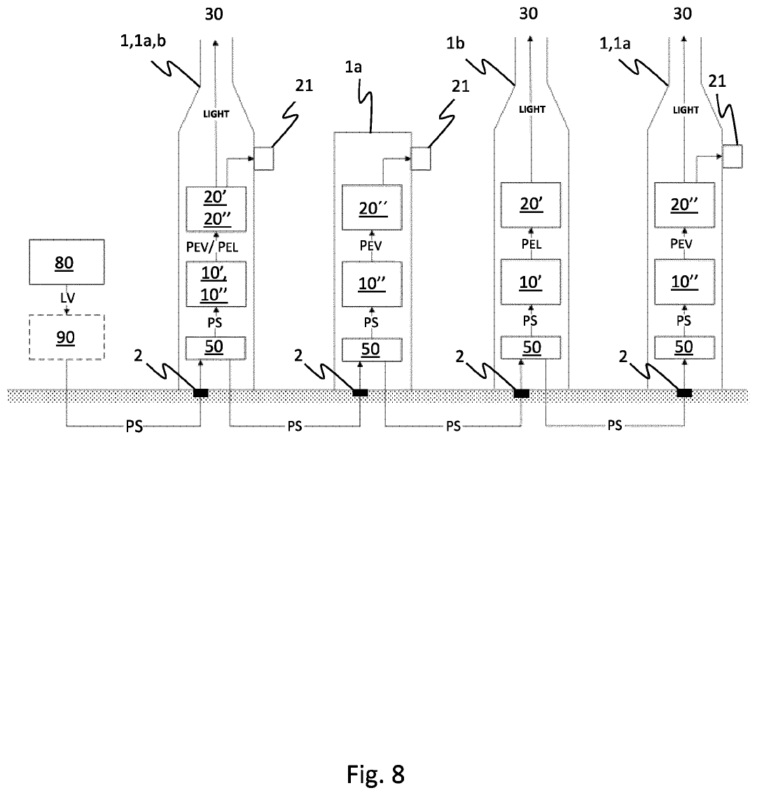

FIG. 8 shows another variant of the inventive charging system where, going from left to right,
the first fixture 1 is a combined lamp post 1b and EV charging station 1a with an SST system 10 including both EVSE SST 10″ and EL SST 10′ and a control device system 20 including both EVSE control device 20″ and EL control device 20′,
the second fixture 1a acts as an EV charging station only with an EVSE SST 10″ and an EVSE control device 20″,
the third fixture 1b acts as an lamp post only with an EL SST 10′ and an EL control device 20′ and
the fourth fixture 1 is a combined lamp post 1b and EV charging station with an EVSE SST 10″ and an EVSE control device 20″.

In the embodiment of FIG. 8 an additional external transformer 90 is indicated. Such external transformer 90 is preferably of type solid state transformer.

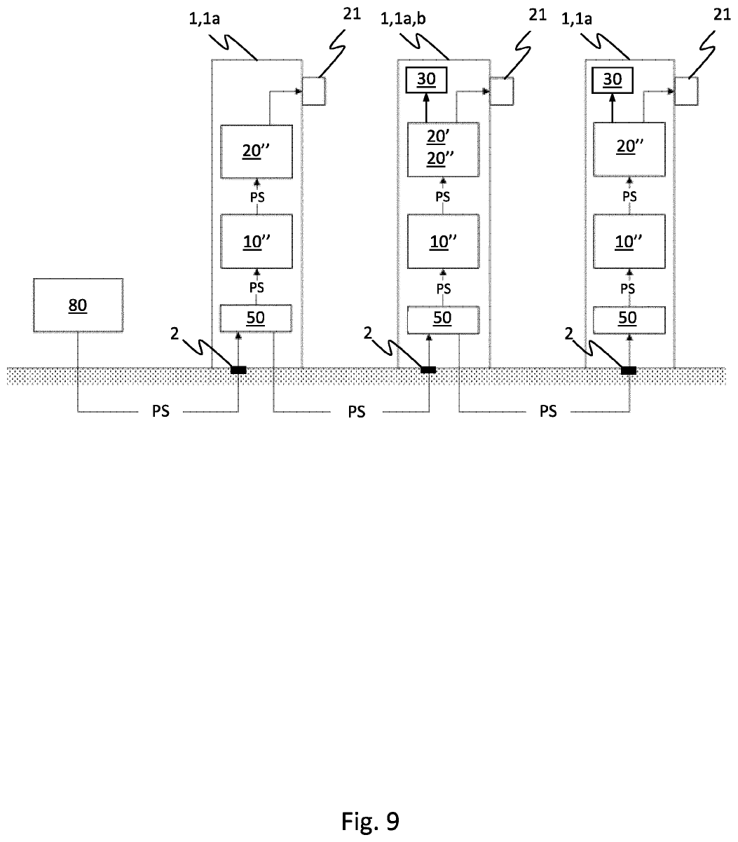

FIG. 9 shows a second embodiment of the invention in which the power level PS supplied by the power grid 80 remains the same also after the SST system 10. Instead, the EVSE SST 10′ is a pure isolation transformer ensuring galvanic isolation between its primary side and its secondary side, and thereby between the EV plug 21/electric load 30 and the power grid 80. Such galvanic isolation may be advantageous in numerous applications, for example in connection with charging of certain loads on IT earthing systems. The charging of the electrical-powered vehicle Renault Zoe® is an example of the latter.

The charging system shown in FIG. 9 comprises, from left to right, a fixture 1a acting as a pure EV charging station, a fixture 1,1a,1b acting as a combined EV charging station and an auxiliary electric load 30 in which the latter has a dedicated EL control device 20″ and a combined EV charging station and an auxiliary electric load 30 in which the latter uses the same SST 10″ and control device 20″ as the EV plug 21.

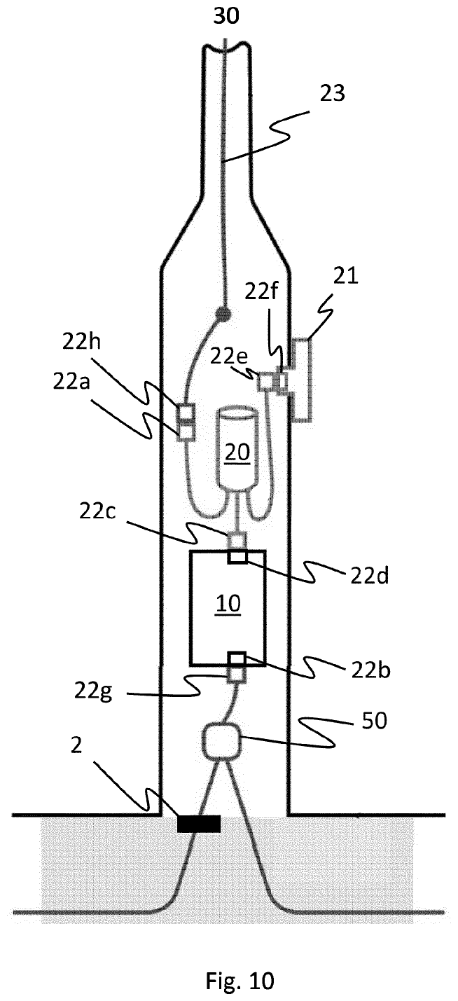

As best described with reference to FIG. 10 a new charging system may be installed into an existing hollow fixture 1b with electric load 30 by performing the following steps:
making an opening into the inner volume of the hollow fixture 1b,
cutting a wire 23 electrically connecting the power inlet 2 to the electrical load 30,
installing an upper and a lower adaptation plug 22h,22g in electrical connection with the electrical load 30 and the power inlet 2, respectively, and
installing the multipurpose charging system in accordance with the specifications above by electrically connecting a control system plug 22a attached to the control system 20 to the upper adaptation plug 22h and electrically connecting a power inlet plug 22b attached to the primary side of the SST system 10 to the lower adaptation plug 22g.

The hollow fixture 1 shown in the embodiment shown in FIG. 10 includes after complete installation a plurality of EVSE plugs 20a-h configured to connect and disconnect the control device 20 and the SST system 10 to/from the respective fixture 1. In addition to the upper and lower adaption plugs 22h,22g, the control system plug 22a and the power inlet plug, the EVSE plugs 20a-h may further include an intermediate EV plug 22e. The above method would then include the step of
installing the EV plug 21 into a second opening giving access to the inner volume and
electrically connecting the intermediate EV plug 22e into a corresponding inner plug 22f of the EV plug 21.

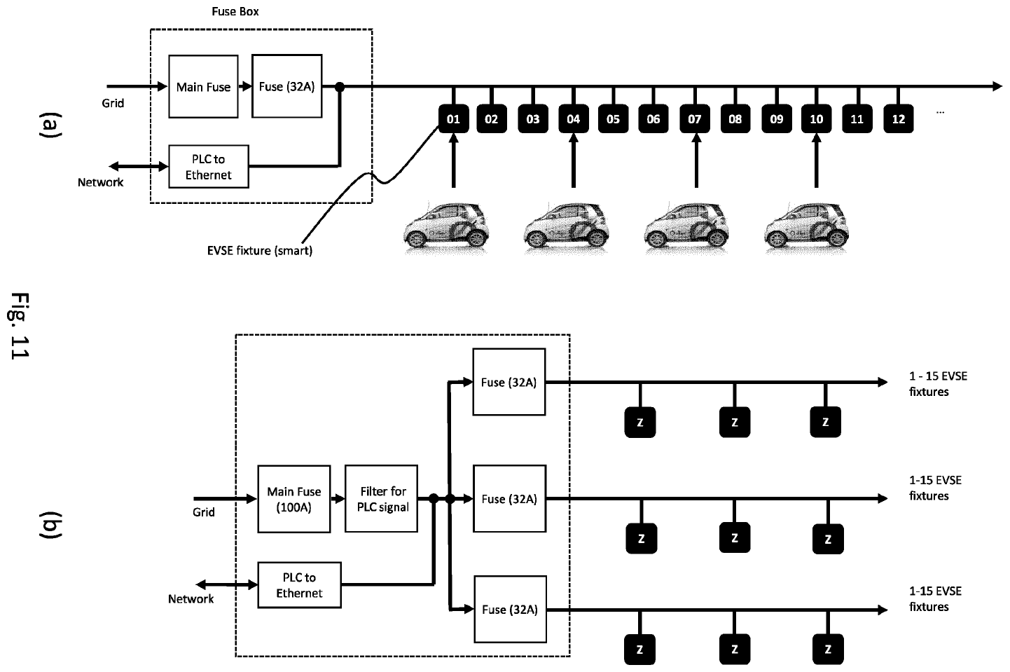

The scalable, multipurpose charging system may advantageously have an intelligent phase distribution system as shown in FIGS. 11(a) and (b). Based on 3-phase power measurements within each of the EVSE fixtures (Z) 1a and exchange of data, comprising this information, between each EVSE fixtures 1a within a certain time period, it is possible to utilize each phase of the 3-phase in the most efficient way. As an example, the first of the four EV's in FIG. 11(a) is connected to the phase having the highest available capacity measured by the EVSE within the EVSE fixture 1a (typically control device system 20 and EV plug 21) that the EV is connected to. Identical power measurements are performed by the remaining EVSE's, and each EV is in turn connected to the phase providing the best capacity at the time of connection. The features of power measurements is integrated in each EVSE and information flow between each EVSE, comprising this power information, is used in an energy distribution algorithm based on a matrix of power relays. This is controlled and monitored by for example a power line communication (PLC) system connected to a network (e.g. wireless local area network (WLAN)) or any variation thereof. This may further be connected to the Internet ensuring remote control of energy distribution. A PLC system can be used to logically interconnect EVSE fixtures. Instead of a PLC, a separate communication line may be used, running parallel to conventional power lines. After exchanging information, each EVSE will connect an EV to a specific phase of the 3-phase power lines according to the capacity and current load detected on the phase. The purpose is optimal use of the capacity of each phase of a 3-phase system.

FIG. 11(b) shows an alternative setup of several EVSE fixtures connected to one phase (1-phase) of a 3-phase network. In contrast to the setup of FIG. 11(a) the 3-phase charging system comprising a 3-phase network that splits up into a number of parallel one-phase distribution lines with EVSE's (Z) connected.

In the preceding description, various aspects of the charging system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiments, as well as other embodiments of the system, which are apparent to persons skilled in the art to which the disclosed subject matter pertains, are deemed to lie within the scope of the present invention.

1-24. (canceled)

25. A charging system for supplying charging power to an electricity-powered vehicle, the charging system comprising
a plurality of spaced apart fixtures constituting part of an urban infrastructure, each fixture having at least one power inlet for receiving electrical energy, wherein at least two of the plurality of fixtures are of type EVSE fixture comprising an EV plug, and an EVSE control device configured to charge, via the EV plug, a rechargeable battery powering the electricity-powered vehicle,
a primary power source arranged outside the at least one EVSE fixture for supplying electric energy (PS) to the at least one power inlet of the at least one EVSE fixture,
a communication module configured to receive and transmit data from/to at least one of the at least one fixture and a computer network and
a phase distribution system based on 3-phase power measurements within each of the EVSE-fixtures and exchange of measured data between each EVSE-fixtures within a certain time period, thereby optimizing use of the capacity of each phase of a 3-phase system.

26. The charging system according to claim 25, wherein the charging system further comprises at least one EVSE solid state transformer having a primary side being electrically connectable to the primary power source for receiving electric energy at a voltage level V_{PS} and a secondary side providing electric energy at a voltage level V_{EVSE}, the secondary side being electrically connectable to the EVSE control device.

27. The charging system in accordance with claim 26, wherein both the EVSE control device and the EVSE solid state transformer system are arranged fully within the at least one fixture.

28. The charging system in accordance with claim 25, wherein the at least one fixture is arranged in, or adjacent to, a road network.

29. The charging system in accordance with claim 25, wherein the charging system is a multipurpose charging system further comprising a second electric load arranged at least partly within the at least one fixture.

30. The charging system in accordance with claim 29, wherein the second electric load comprises a light source for providing street light to roads in a road network.

31. The charging system in accordance with claim 30, wherein the second electric load is electrically connectable to the EVSE control device.

32. The charging system in accordance with claim 26, wherein the charging system is a multipurpose charging system further comprising a second electric load arranged at least partly within the at least one fixture, wherein each of the at least one fixture contains a solid state transformer system comprising the EVSE solid state transformer and a second solid state transformer arranged within at least one of the at least one fixture, the second solid state transformer comprising a primary side being electrically connectable to the primary power source for receiving electric energy at the voltage level VPS and a secondary side providing electric energy at a voltage level VEL, the secondary side being electrically connectable to the second electric load.

33. The charging system in accordance with claim 32, wherein the second solid state transformer is connected in parallel to the EVSE solid state transformer within the solid state transformer system.

34. The charging system in accordance with claim 26, wherein the primary side of the EVSE solid state transformer is electrically isolated from the secondary side of the EVSE solid state transformer.

35. The charging system in accordance with claim 26, wherein the voltage level VPS is higher than the voltage level VEVSE.

36. The charging system in accordance with claim 26, wherein the voltage level VPS is equal to, or approximately equal to, the voltage level VEVSE.

37. The charging system in accordance with claim 26, wherein each EVSE fixture of the at least one fixture comprises
monitoring means configured to monitor physical parameters descriptive of the performance of the EVSE solid state transformer and
transmission means configured to allow access and transmission of the physical parameters to computer networks.

38. The charging system in accordance with claim 37, wherein the primary side of the EVSE solid state transformer is electrically isolated from the secondary side of the EVSE solid state transformer, and that the monitoring means and the transmission means are configured to detect and to transmit, respectively, any insulation fault occurring within the EVSE solid state transformer.

39. The charging system in accordance with claim 38, wherein the EVSE solid state transformer comprises a protection device enabling measurement and/or detection at least one of the parameters
transient overvoltage,
undervoltage,
power consumption,
earth fault,
excess temperature and
electric noise,
followed by transmission of the at least one parameter to a computer network.

40. The charging system in accordance with claim 25, wherein the charging system further comprises a communication module configured to receive and transmit data from/to at least one of the at least one fixture and a computer network.

41. The charging system in accordance with claim 40, wherein the communication module is further configured to receive and transmit data from/to the primary power source.

42. The charging system in accordance with claim 26, wherein each EVSE fixture comprises an EVSE data communication device enabling reception and transmission of data between the EVSE control device and the EVSE solid state transformer.

43. The charging system in accordance with claim 25, wherein the EV plug comprises an EV power outlet and an EV communication module, wherein the EV communication module is configured to transmit data to a computer network.

44. The charging system in accordance with claim 25, wherein each fixture comprises a connection box comprising a plurality of relays, the connection box being configured to electrically connect and disconnect the at least one power inlet of one of the fixtures and electrically connect and disconnect the at least one power inlet with the at least one power inlet of another of the fixtures within the charging system.

45. The charging system in accordance with claim 26, wherein each EVSE fixture comprises a plurality of EVSE plugs configured to connect and disconnect the EVSE control device to/from the respective EVSE fixtures, the EVSE plugs comprising a control system plug electrically connected to the EVSE control device and a power inlet plug at the power inlet.

46. A method using an existing, hollow fixture connected to a primary power source via at least one power inlet in order to provide charge for a rechargeable battery powering an electricity-powered vehicle, the fixture comprising an electrical load, wherein the method comprises the steps of
making at least one opening into the inner volume of the hollow fixture,
cutting or removing at least one wire electrically connecting the power inlet to the electrical load,
installing an upper and a lower adaptation plug in electrical connection with the electrical load and the power inlet, respectively, and
installing the charging system in accordance with claim 45 by
electrically connecting the control system plug to the upper adaptation plug and
electrically connecting the power inlet plug to the lower adaptation plug.

47. The method in accordance with claim 46, wherein the EVSE plugs further comprises an intermediate EV plug, wherein the method further comprises the step of
installing the EV plug into one of the at least one opening and
electrically connecting the intermediate EV plug into a corresponding inner plug of the EV plug.
